(19) United States
(12) Patent Application Publication
(10) Pub. No.: US 2014/0136243 A1
(43) Pub. Date: May 15, 2014

(54) SYSTEM AND METHOD FOR LOSS ANALYSIS

(71) Applicant: HARTFORD FIRE INSURANCE COMPANY, Hartford, CT (US)

(72) Inventors: Douglas W. Davis, Overland Park, KS (US); James R. Mitchell, Lawrenceville, GA (US)

(73) Assignee: HARTFORD FIRE INSURANCE COMPANY, Hartford, CT (US)

(21) Appl. No.: 13/675,331

(22) Filed: Nov. 13, 2012

(51) Int. Cl. G06Q 40/08

(52) U.S. Cl. 705/4

(57) ABSTRACT

According to some embodiments, loss data may be received. The received loss data may be used to populate cells in a pivot data worksheet in a spreadsheet application workbook. At least one pivot table in at least one pivot table worksheet of the spreadsheet application workbook may be automatically created based on the pivot data worksheet. According to some embodiments, the pivot table includes cells that summarize the loss data associated with the insurance claims submitted under an insurance policy.

### BACKGROUND

An insurer may provide payments when claims are made in connection with an insurance policy. For example, an employee who is injured while working might receive a payment associated with an insurance policy purchased by his or her employer. By analyzing the types of injuries, the payment amounts, etc., associated with a large number of claims, it may be possible to detect patterns that can be used to improve workplace safety. For example, if it is determined that employees are much likely to be injured after 10:00 PM, certain precautions could be taken to reduce the likelihood of such injuries.

Manually looking for these types of patterns, however, can be time consuming task, especially when there are a substantial number of claims to be analyzed. Moreover, certain patterns may be hard to detect. It would therefore be desirable to provide systems and methods to facilitate analysis of loss data, such as insurance claim loss data and/or client operation data, in an automated, efficient, and accurate manner.

### SUMMARY OF THE INVENTION

According to some embodiments, systems, methods, apparatus, computer program code and means may provide a tool to facilitate analysis of loss data. In some embodiment, loss data associated with insurance claims submitted under an insurance policy is received via a communication device. The received loss data may then be used to populate cells in a pivot data worksheet in a spreadsheet application workbook. A computer processor may automatically create, based on the pivot data worksheet, at least one pivot table in at least one pivot table worksheet of the spreadsheet application workbook. The pivot table may, for example, include cells that summarize the loss data associated with the insurance claims submitted under the insurance policy.

Some embodiments provide: means for receiving, via a communication device, loss data associated with insurance claims submitted under an insurance policy; means for using the received loss data to populate cells in a pivot data worksheet in a spreadsheet application workbook; and means for automatically creating, by a computer processor based on the pivot data worksheet, at least one pivot table in at least one pivot table worksheet of the spreadsheet application workbook, the pivot table including cells that summarize the loss data associated with the insurance claims submitted under the insurance policy

A technical effect of some embodiments of the invention is an improved and computerized method to facilitate analysis of loss data. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a software application workbook according to some embodiments.

FIG. 3 illustrates a method that might be performed in accordance with some embodiments.

FIG. 4 illustrates a pivot data worksheet according to some embodiments of the present invention.

FIG. 5 illustrates a working data worksheet according to some embodiments of the present invention.

FIG. 6 illustrates a formula tables worksheet according to some embodiments of the present invention.

FIG. 7 illustrates a table of contents worksheet according to some embodiments of the present invention.

FIG. 8 illustrates a line of business worksheet according to some embodiments of the present invention.

FIG. 9 illustrates a largest losses worksheet according to some embodiments of the present invention.

FIG. 10 illustrates a loss stratification worksheet according to some embodiments of the present invention.

FIG. 11 illustrates a revenue offset worksheet according to some embodiments of the present invention.

FIG. 12 is block diagram of a loss analysis tool or platform according to some embodiments of the present invention.

FIG. 13 is a tabular portion of a loss data database according to some embodiments.

FIG. 14 illustrates a handheld tablet display in accordance with some embodiments described herein.

### DESCRIPTION

An insurer may provide payments when claims are made in connection with an insurance policy. For example, an employee who is injured while working might receive a payment in accordance with a workers' compensation insurance policy purchased by his or her employer. An employer and/or insurance provider may be interested in avoiding accidents and/or reducing losses associated with an insurance policy and/or a business. By analyzing the types of injuries, the payment or loss amounts, etc., associated with a large number of claims, patterns might be detected that can be used to improve workplace safety and reduce loss amount. Having a data analyst manually search for such patterns, however, can be time consuming task, especially when there are a large number of claims. Moreover, certain types of patterns can be hard for a data analyst to detect.

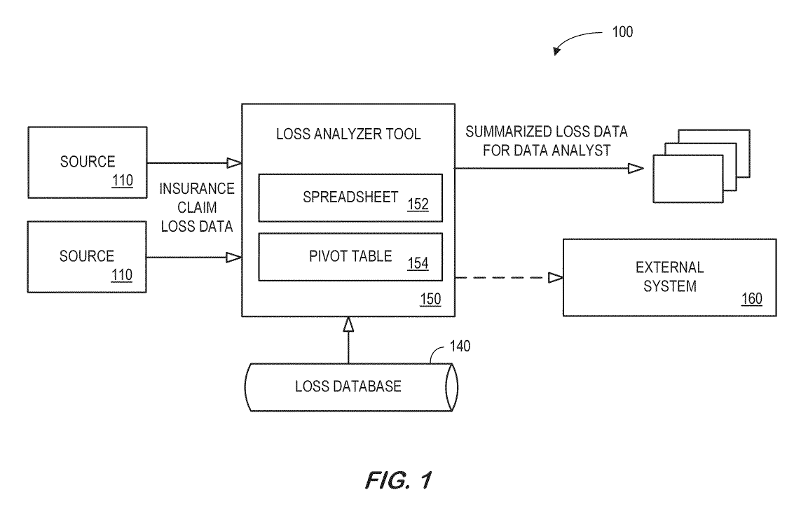

It would therefore be desirable to provide systems and methods to facilitate analysis of loss data in an automated, efficient, and accurate manner. FIG. 1 is block diagram of a system 100 according to some embodiments of the present invention. In particular, the system 100 includes a loss analyzer tool 150 that receives loss data from one or more sources 110 (e.g., by receiving an electronic file from a client, an employee or insurance agent or accessing a loss database 140). The loss analyzer tool 150 might be, for example, associated with a Personal Computers (PC), laptop computer, an enterprise server, a server farm, and/or a database or similar storage devices. The loss analyzer tool 150 may, according to some embodiments, be associated with a business organization or an insurance provider.

The sources 110 may be associated with, for example, a client database, a third party administrator, a prior insurance provider, and/or current claim data that has been exported to a spreadsheet application. According to some embodiments, the sources 110 may be associated with operational data provided by a client and/or a combination of insurance and operational data. The operational data might include, for example, an area of a business in square feet and/or a failure or “scrap” rate for a manufacturer. The loss data provided by any of the sources 110 might be associated with, for example, operational business losses and/or losses associated with insurance claims (e.g., workers' compensation insurance, automobile insurance, or general liability insurance).

According to some embodiments, an “automated” loss analyzer tool 150 may facilitate generation of summarized loss data for an analyst. As used herein, the term “automated” may refer to, for example, actions that can be performed with little or no human intervention.

As used herein, devices, including those associated with the loss analyzer tool 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The loss analyzer tool 150 may store information into and/or retrieve information from the loss database 140. The loss database 140 might be associated with, for example, a client, an employer, or insurance policy and might be based on data associated with past insurance claims. The loss database 140 may be locally stored or reside remote from the insurance claim loss analyzer tool 150. As will be described further below, the loss database 140 may be used by the loss analyzer tool 150 to generate summarized loss data (e.g., via a spreadsheet application or similar type of report). According to some embodiments, the loss analyzer tool 150 communicates the summarized data to an external system 160, such as by transmitting an electronic file to a client device, an insurance agent or analyst platform, email server, workflow management system, etc. The summarized data may then be used by a data analyst to look for patterns that may be used to improve workplace safety (which in turn may also reduce insurance costs for the client).

Although a single loss analyzer tool 150 is shown in FIG. 1, any number of such devices may be included. Moreover, various devices described herein might be combined according to embodiments of the present invention. For example, in some embodiments, the claim loss analyzer tool 150 and loss database 140 might be co-located and/or may comprise a single apparatus.

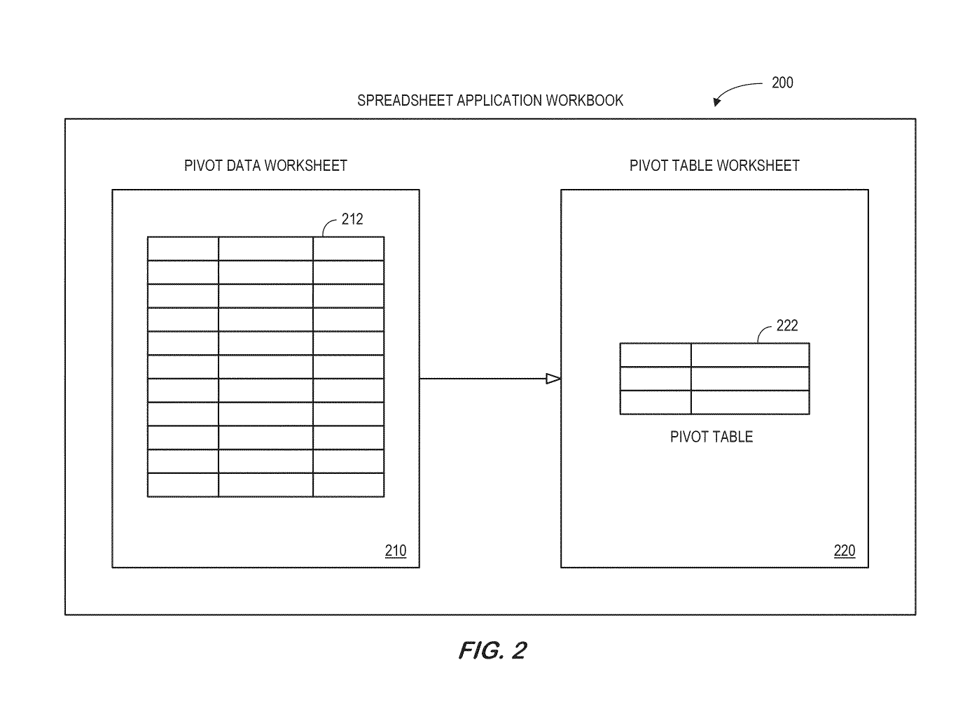

According to some embodiments, the summarized loss data generated by the loss analyzer tool is provided via a spread sheet application. For example, FIG. 2 illustrates a software application workbook 200 according to some embodiments. As used herein, the term “workbook” may refer to any spreadsheet application file, such as an EXCEL® spreadsheet application having multiple pages, tabs, or “sheets.” The workbook 200 includes a pivot data worksheet 210 that contains cells 212 storing information about prior insurance claim losses (e.g., each row may represent an insurance claim made by an employee and the various columns may store information about the claim, such as the date the claim was submitted, the date of injury, employee name, loss amount, etc.) and client operation data (e.g., each row may represent elements of a client's operation, such as work shifts, equipment, material, people, etc.) According to some embodiments, the pivot data worksheet 210 is used to automatically create, in a pivot table worksheet 220, a pivot table having cells 222 that summarize the information in the pivot data worksheet 210. The pivot table may then be used by a data analyst to look for patterns that may be used to improve workplace safety and client operations. As used herein, the phrase “pivot table” may refer to, for example, a data summarization tool associated with data visualization programs such as spreadsheets or business intelligence software. A pivot table may, according to some embodiments, help automatically sort, count, total or average data stored in a table or spreadsheet. The pivot table tool may display the results in a separate table (i.e., the “pivot table”). According to some embodiments, a user may change the table's structure by dragging and dropping fields graphically.

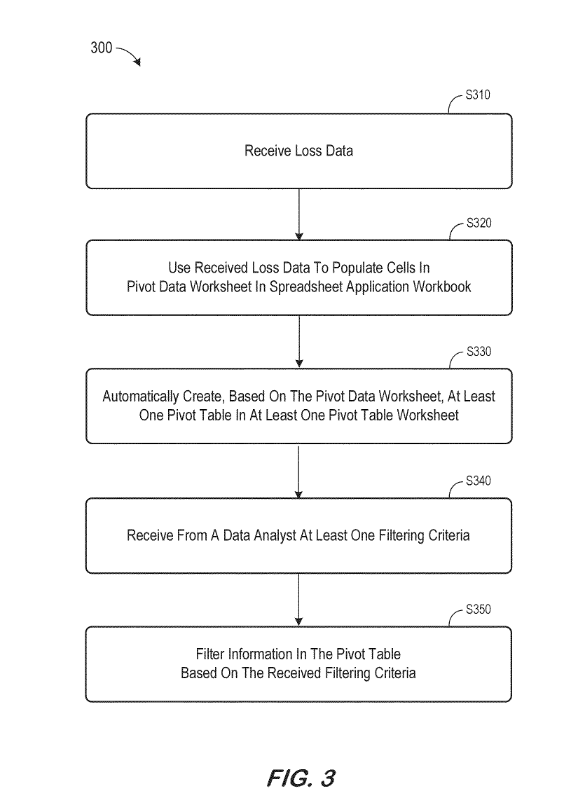

For example, FIG. 3 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, loss data associated is received. The loss data might be received from one or more sources and may be associated with insurance claims submitted under an insurance policy and/or operational loss data. The loss data might comprise, for example, an electronic file having multiple records representing claims that have been submitted. The loss data might include, by way of examples only, (i) an insurance policy number, (ii) a line of business code, (iii) a claim number, (iv) a claimant name, (v) a claimant birth date, (vi) a claimant age, (vii) a claimant gender, (viii) a claimant date hired, (ix) a claimant length employed, (x) an accident date, (xi) an accident time, (xii) an accident state, (xiii) an accident city, (xix) a location name, (xx) a location code, (xxi) a claim description, (xxii) an accident description, (xxiii) a claimant occupation, (xxiv) an injured body part and injury type, (xxv) a claim status, (xxvi) a number of disability days, (xxvii) a date reported to carrier, (xxviii) a date reported by claimant, (xxix) a total paid cost, and/or (xxx) a total incurred cost associated with the insurance claim.

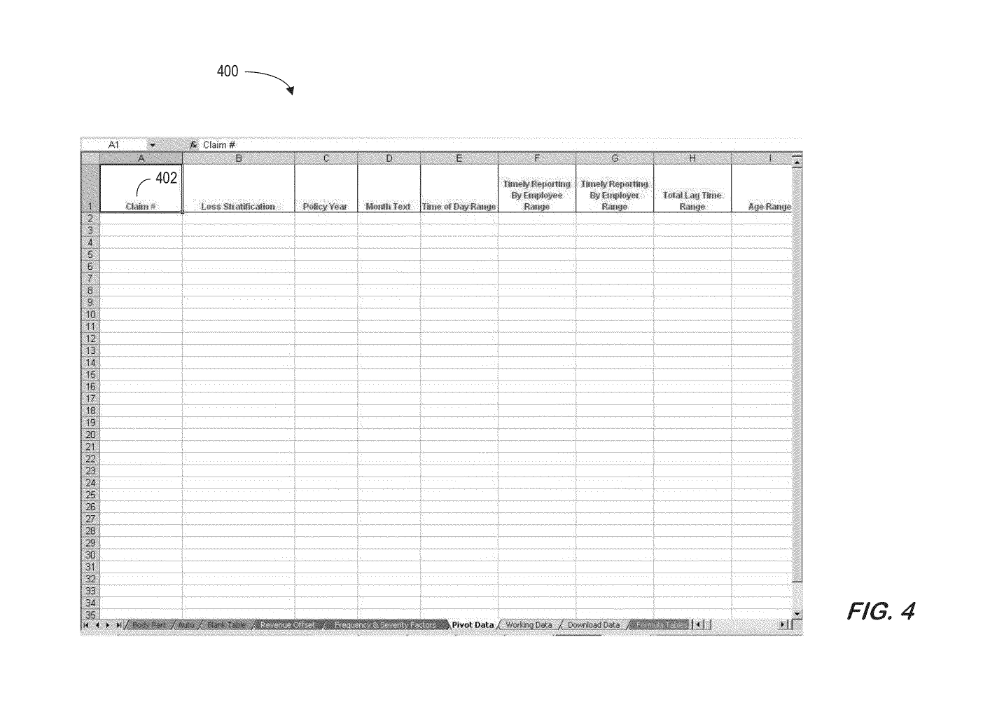

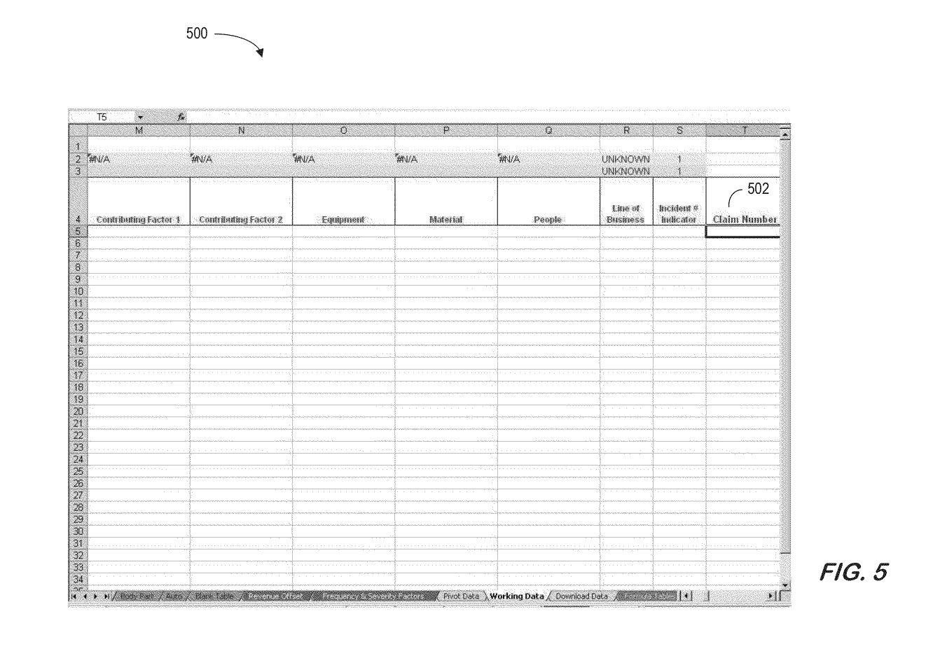

At S320, the received loss data is used to populate cells in a pivot data worksheet in a spreadsheet application workbook. The population of the cells may be, for example, a manual process, an automated process, or a combination of manual and automated processes. According to some embodiments, the data may be imported into a “download” and/or “working” data worksheet and the cells of the download data worksheet are manually mapped or copied to cells of the pivot data worksheet (e.g., via a cut and paste operation). For example, FIG. 4 illustrates a pivot data worksheet 400 referencing a claim number 402, policy year, etc. according to some embodiments of the present invention and FIG. 5 illustrates a working data worksheet 500 referencing a claim number 502, contributing factors, etc. according to some embodiments of the present invention. In this case, a cut and past operation may be used to transfer data between the worksheets 400, 500 as appropriate.

Note that according to some embodiments, a manual entry of supplemental loss data by a data analyst may be provided. In the example of FIG. 5, the data analyst might provide or modify contributing factors as appropriate. Moreover, according to some embodiments, at least one algorithm may be automatically applied to populated cells in the working data worksheet. For example,

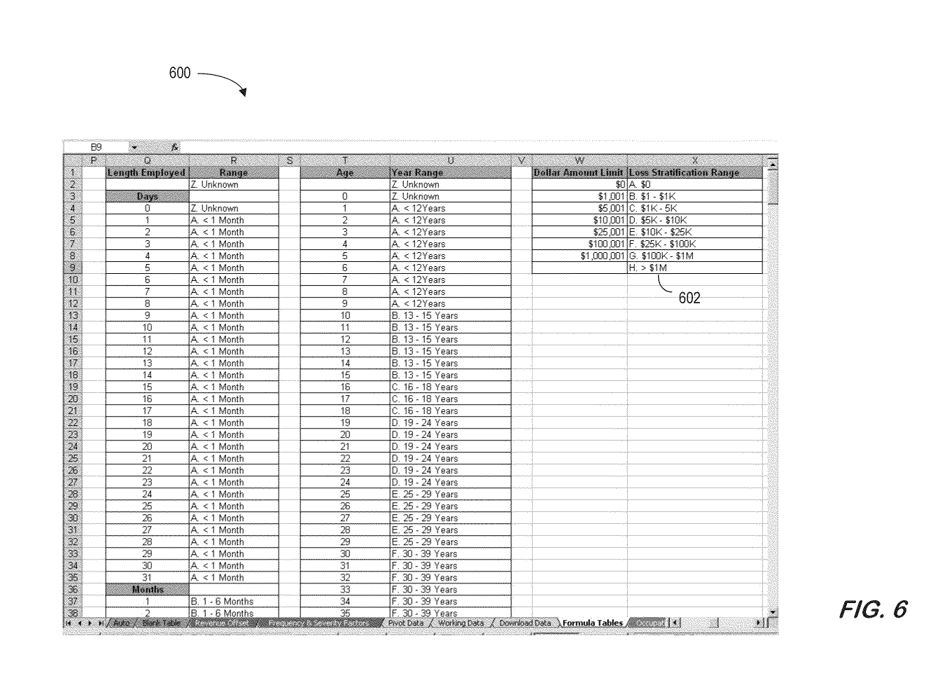

FIG. 6 illustrates a formula tables worksheet 600 according to some embodiments of the present invention. The formula tables worksheet 600 might include, for example, stratification definitions 602 (e.g., to classify an insurance claim loss amount as being “from $10K to $25K”). A worksheet 600 such as the one illustrated in FIG. 6 may, for example, let a data analyst customize such stratification definitions 602 for a particular client.

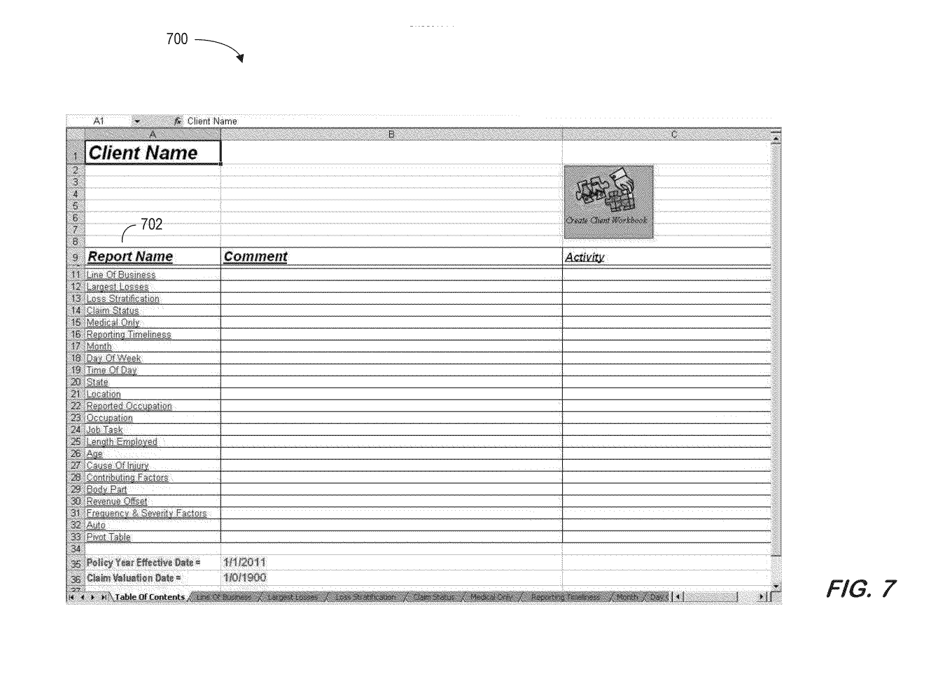

Referring again to FIG. 3, at least one pivot table in at least one pivot table worksheet of the spreadsheet application workbook is automatically created at S330 based on the pivot data worksheet. The pivot table may include, for example, cells that summarize the loss data associated with the insurance claims submitted under the insurance policy. Note that the loss data may be summarized in a number of different ways, such as by the “line of business” associated with the injuries. For example, FIG. 7 illustrates a table of contents worksheet 700 that may provide summarized data, in various report formats 702 including line of business, according to some embodiments of the present invention.

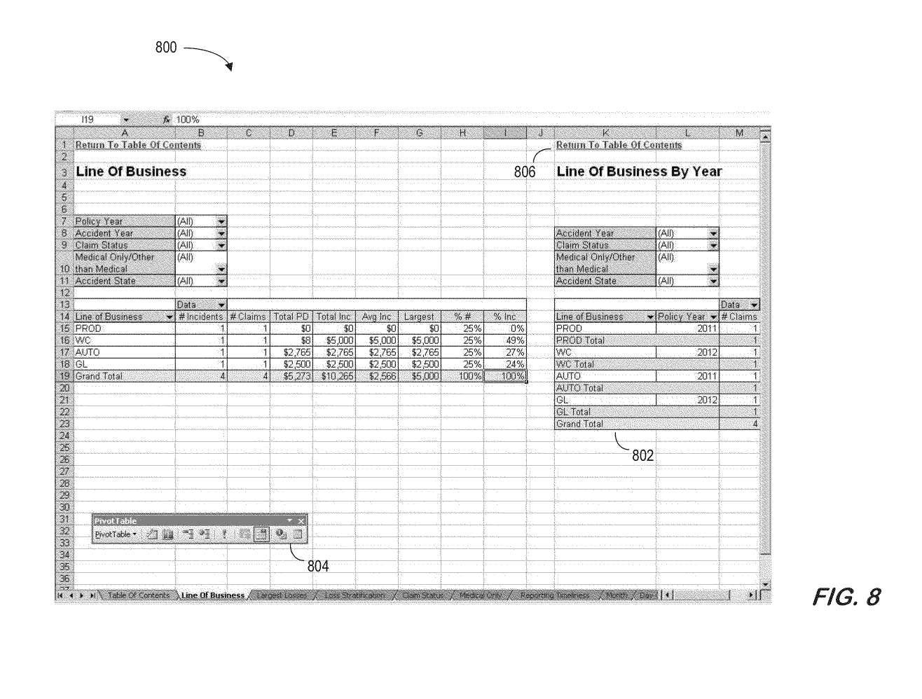

When the data analyst selects the line of business report format 702 (e.g., by clicking on the “line of business” link), a line of business worksheet 800 such as the one illustrated in FIG. 8 may be provided according to some embodiments of the present invention. The worksheet 800 includes a pivot table 802 that displays how many claims were submitted on a yearly basis under an insurance policy for each line of business (e.g., “Prod,” “WC,” “Auto,” and “GL”). A pivot table bar 804 may let the analyst modify and/or supplement the displayed information. The analyst may also select a “Return To Table Of Contents” link to return to the table of contents worksheet 700 of FIG. 7. Note that the pivot table 802 illustrated in FIG. 8 includes loss data associated different types of insurance products, including workers' compensation, automobile, and general liability insurance policies.

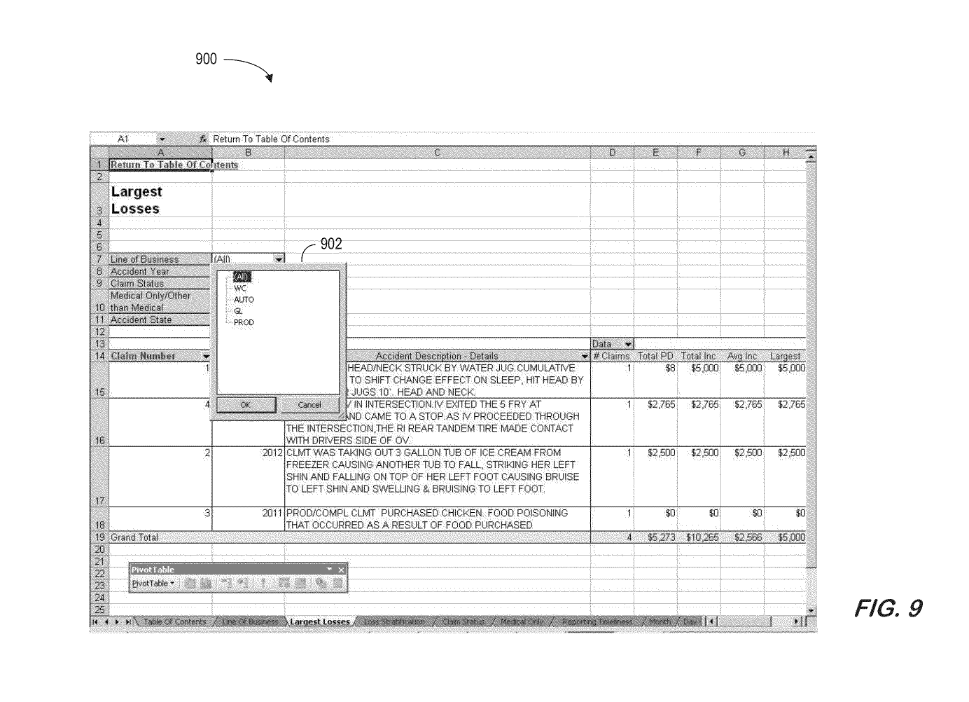

Instead of or in addition to being summarized based on the line of business, note that loss data can be summarized in any number of different ways. For example, FIG. 9 illustrates a largest losses worksheet 900 (summarizing based on the insurance claim loss amount) according to some embodiments of the present invention. Note that the largest losses worksheet 900 may include a user interface area 902 that can be used, for example, by a data analyst to further modify the display information. In particular, the user interface area 902 illustrated in FIG. 9 includes selections associated different types of insurance products (e.g., workers' compensation, automobile, and general liability insurance policies) and may let a data analyst “drill down” to sort and filter the type of loss information included in the worksheet 900. The worksheet 900 can be used to pick on or more lines of business and a total number of claims, total incurred cost, average costs, etc. can then be displayed as appropriate.

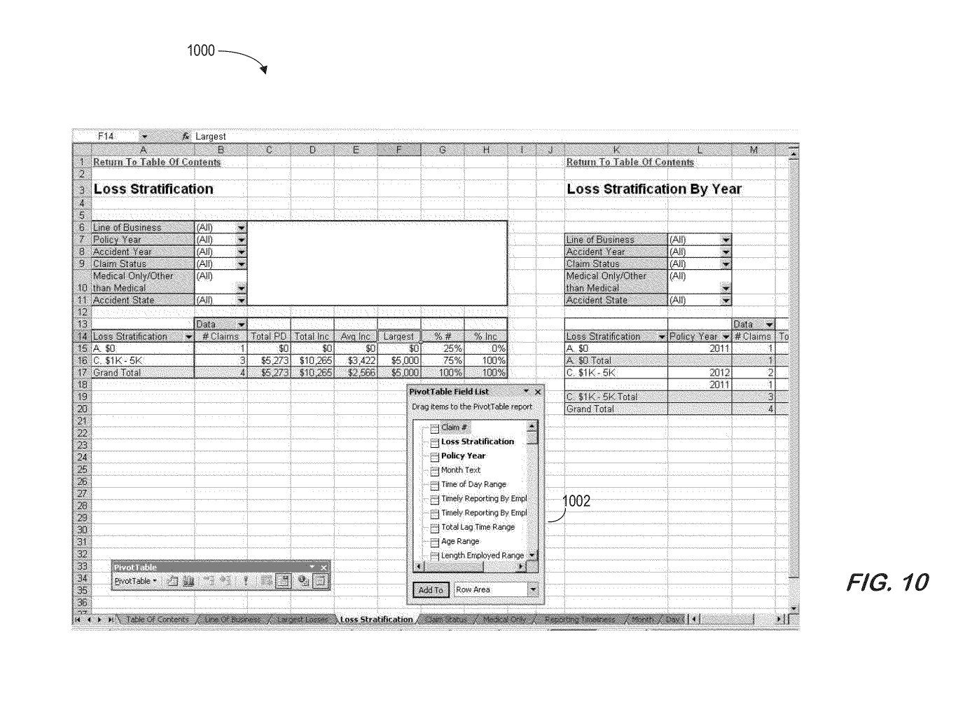

As still another example, FIG. 10 illustrates a loss stratification worksheet 1000 that shows, for example, data about all claims having a loss amount of between $1K and $5K. Note that the loss stratification worksheet 1000 may include a pivot table field list interface area 1002 that may be used, for example, by a data analyst to add or remove information from various pivot tables. Other examples ways in which the loss data might be summarized include” claim status, reporting timeliness, month of injury, day of week, state and/or city, occupation, length employed, age, claim type, contributing factor descriptions, and/or which body part of the employee has been injured. Such a worksheet 1000 may be used, for example, by a data analyst to add age ranges, loss amount ranges, date ranges, etc. to help review the data looking for patterns that may be used to reduce losses. Note that any of the pre-set preferences associated with the worksheet 100 may be customized by the data analyst in view of the data and/or the particular client so the data may be cut and/or viewed in an appropriate manner.

Referring again to FIG. 3, at least one filtering criteria may be received from a data analyst at S340. At S350, information in the pivot table may be filtered based on the received filtering criteria. For example, an analyst might want to focus only on a particular type of injury to detect patterns than may be used to improve workplace safety. Similarly, at least one sorting criteria might be receive from the data analyst, in which case the information in the pivot table mat be sorted as appropriate based on the received sorting criteria. For example, the analyst might want to list various summarized information based on how many days of work an employee missed as a result of his or her injury. According to some embodiments, at spreadsheet application workbook customization may be received from the data analyst (e.g., various fields might be added, filtered, sorted, etc.). In this case, the spreadsheet application workbook customization may be stored such that when additional loss data is received (e.g., during next years review) it can be added to the pivot table in accordance with his or her previously established spreadsheet application customization. Moreover, according to some embodiments, some or all of any of the pivot tables described here may be exported. For example, a portion of a pivot table may be provided to a client that includes summarized insurance data without including all of the algorithms, definitions, etc. that were used to create the pivot table.

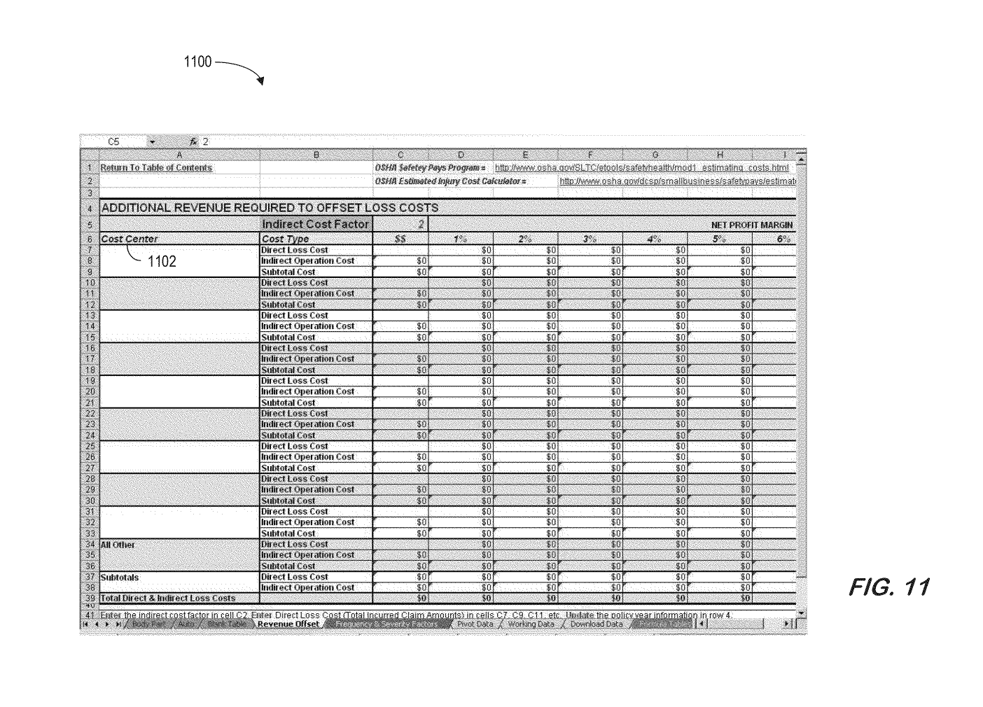

FIG. 11 illustrates a revenue offset worksheet 1100 according to some embodiments of the present invention. The revenue offset worksheet 1100 displays loss data across various cost centers 1102 and may be used to emphasize to a client how serious various types of injuries may be (in connection with net profit margin impacts, direct loss costs, and indirect loss costs). A worksheet 1100 such as the one illustrated in FIG. 11 may be used, for example, by a data analyst to help present loss information to a client in a meaningful way. The worksheet 1100 may include direct lost costs (e.g., incurred claim costs) and indirect operational costs (e.g., claim investigation costs) along with an impact to a net profit margin. According to some embodiments, a client may be provided with an amount of revenue increase that would be needed to cover the losses on the worksheet 1100.

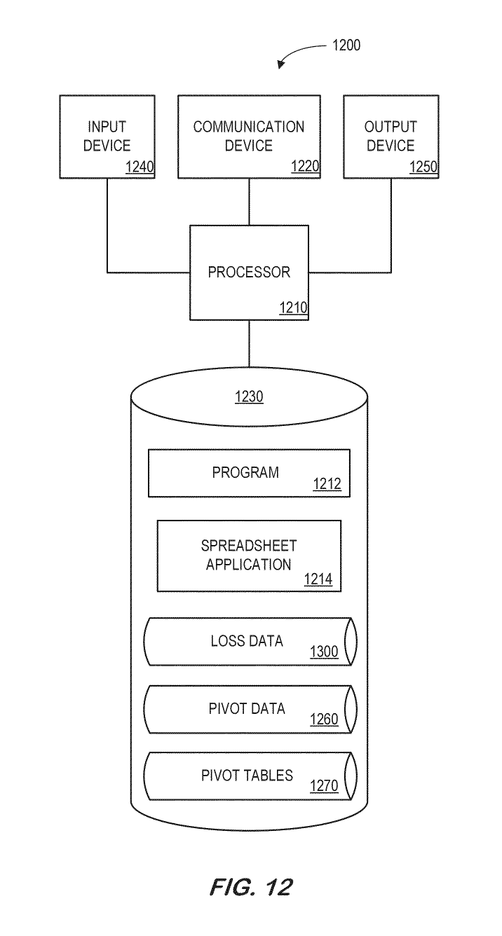

The embodiments described herein may be implemented using any number of different hardware configurations. For example, FIG. 12 illustrates an insurance claim loss analyzer tool 1200 that may be, for example, associated with the system 100 of FIG. 1. The insurance claim loss analyzer tool 1200 comprises a processor 1210, such as one or more commercially available Central Processing Units (CPUs) in the form of one-chip microprocessors, coupled to a communication device 1220 configured to communicate via a communication network (not shown in FIG. 12). The communication device 1220 may be used to communicate, for example, with one or more remote project leader devices. The insurance claim loss analyzer tool 1200 further includes an input device 1240 (e.g., a mouse and/or keyboard to navigate between and/or enter adjustments to pivot tables) and an output device 1250 (e.g., a computer monitor to display pivot tables).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1212 and/or a spreadsheet application 1214 (e.g., associated with a spreadsheet application plug-in) for controlling the processor 1210. The processor 1210 performs instructions of the programs 1212, 1214, and thereby operates in accordance with any of the embodiments described herein. For example, the processor 1210 may receive loss data associated with insurance claims submitted under an insurance policy. The received loss data may be used to by the processor 1210 to populate cells in a pivot data worksheet in a spreadsheet application workbook. At least one pivot table in at least one pivot table worksheet of the spreadsheet application workbook may be automatically created by the processor 1210 based on the pivot data worksheet. According to some embodiments, the pivot table includes cells that summarize the loss data associated with the insurance claims submitted under the insurance policy.

The programs 1212, 1214 may be stored in a compressed, uncompiled and/or encrypted format. The programs 1212, 1214 may furthermore include other program elements, such as an operating system, a database management system, and/or device drivers used by the processor 1210 to interface with peripheral devices.

As used herein, information may be “received” by or “transmitted” to, for example: (i) the insurance claim loss analyzer tool 1200 from another device; or (ii) a software application or module within the insurance claim loss analyzer tool 1200 from another software application, module, or any other source.

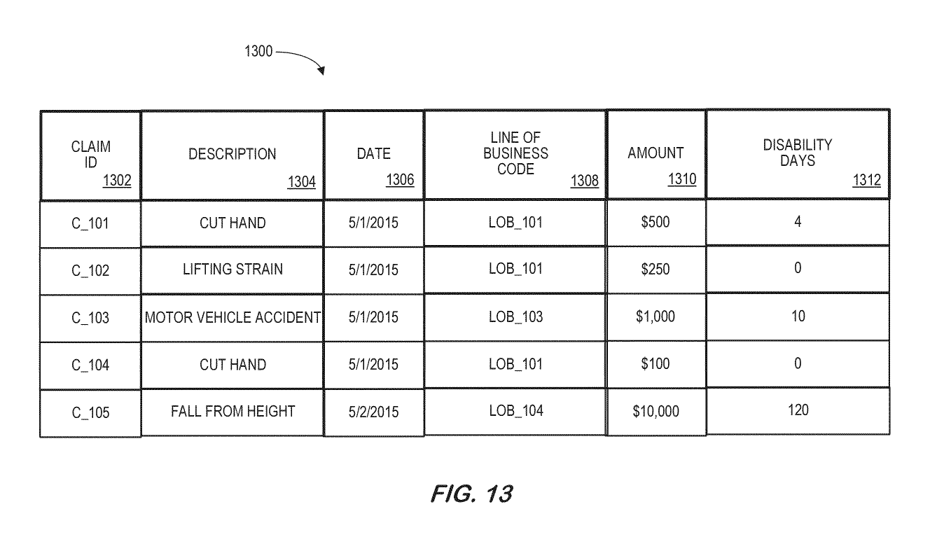

In some embodiments (such as shown in FIG. 9), the storage device 1230 further stores a loss data database 1300, a pivot data database 1270, and a pivot table database 1270. An example of a database that may be used in connection with the insurance claim loss analyzer tool 1200 will now be described in detail with respect to FIG. 13. Note that the database described herein is only one example, and additional and/or different information may be stored therein. Moreover, various databases might be split or combined in accordance with any of the embodiments described herein. For example, the pivot data database 1260 and/or pivot tables 1270 might be combined and/or linked to each other within the spreadsheet application 1214.

Referring to FIG. 13, a table is shown that represents the loss data database 1300 that may be stored at the insurance claim loss analyzer tool 1200 according to some embodiments. The table may include, for example, entries identifying insurance claims submitted under a particular insurance policy or policies. The table may also define fields 1302, 1304, 1306, 1308, 1310, 1312 for each of the entries. The fields 1302, 1304, 1306, 1308, 1310, 1312 may, according to some embodiments, specify: a claim identifier 1302, a description 1304, a date 1306, a line of business code 1308, an amount 1310, and a number of disability days 1312. The loss data database 1300 may be created and updated, for example, based on information from a client or a database.

The claim identifier 1302 may be, for example, a unique alphanumeric code identifying a claim submitted in connection with an insurance policy. The description 1304 might describe the injury and/or categorize how the injury occurred (e.g., “lifting strain” or “fall from height”). The date 1306 might reflect when the accident occurred and the line of business code 1308 might indicate a type of work associated with the injury. The amount 1310 may represent a monetary loss or amount paid by the insurer and the number of disability days 1312 may indicate how long the employee was out of work as a result of the accident. The information in the loss data database 1300 may be used, for example, to create one or more pivot tables that summarize the information.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with insurance policies associated with injuries occurring at a client's location or as a result of client's involvement. Note, however, that other types of insurance policies may also benefit from the invention. For example, embodiments of the present invention may be used in connection with automobile insurance policies, etc.

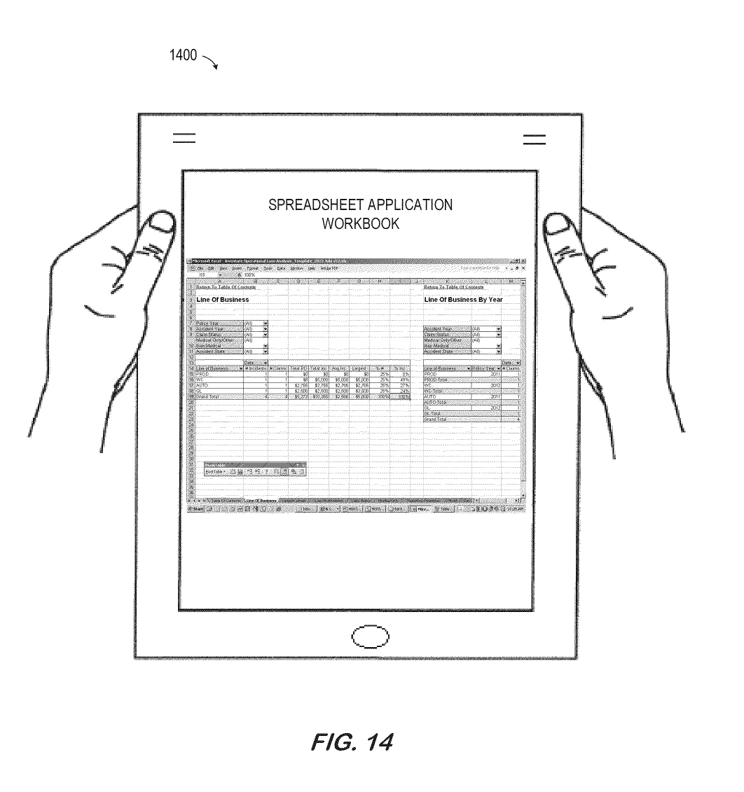

Moreover, some embodiments have been described herein as being accessed via a PC or laptop computer. Note, however, that embodiments may be implemented using any device capable of executing the disclosed functions and steps. For example, FIG. 14 illustrates a display 1400 in accordance with some embodiments described herein. In particular, the display 1400 includes a graphical user interface including information about summarized loss data via pivot tables.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system for analyzing loss data, comprising:
a communication device to receive loss data from a plurality of sources;
a computer processor for executing program instructions; and
a memory, coupled to the computer processor, for storing program instructions for execution by the computer processor for:
using the received loss data to populate cells in a pivot data worksheet in a spreadsheet application workbook, and
automatically creating, based on the pivot data worksheet, at least one pivot table in at least one pivot table worksheet of the spreadsheet application workbook, the pivot table including cells that summarize the loss data associated with the insurance claims submitted under the insurance policy.

2. The system of claim 1, wherein the loss data comprises insurance claim loss data submitted under an insurance policy.

3. The system of claim 2, wherein the insurance claim loss data is associated with at least one of: (i) workers' compensation insurance, (ii) automobile insurance, and (iii) general liability insurance.

4. The system of claim 3, wherein the insurance claim loss data is associated with a plurality of different types of insurance.

5. The system of claim 1, wherein the loss data is associated with at least one of: (i) operational loss data, (ii) direct operational costs, and (iii) indirect operational costs.

6. The system of claim 1, wherein said using the received loss data includes importing the data into a download data worksheet and mapping cells of the download data worksheet to cells of the pivot data worksheet.

7. The system of claim 1, wherein the memory further stores program instructions for execution by the computer processor for:
prior to said automatic creation of the at least one pivot table, facilitating a manual entry of supplemental loss data by a data analyst.

8. The system of claim 1, wherein the memory further stores program instructions for execution by the computer processor for:
prior to said automatic creation of the at least one pivot table, automatically applying at least one algorithm to populated cells in the pivot data worksheet.

9. The system of claim 1, wherein the memory further stores program instructions for execution by the computer processor for:
receiving from a data analyst at least one filtering criteria, and
filtering information in the pivot table based on the received filtering criteria.

10. The system of claim 9, wherein the memory further stores program instructions for execution by the computer processor for:
receiving from the data analyst at least one sorting criteria, and
sorting information in the pivot table based on the received sorting criteria.

11. The system of claim 10, wherein at least one of the filtering criteria and the sorting criteria are associated with: (i) a date, (ii) a claim value, (iii) a number of claims, (iv) an injury type, (v) a worker's experience, (vi) a worker's age, (vii) a length of absence, (viii) a type of insurance, (ix) a claim status, and (x) a claim lag time.

12. The system of claim 1, wherein the memory further stores program instructions for execution by the computer processor for:
receiving from a data analyst at spreadsheet application workbook customization,
storing the spreadsheet application workbook customization,
receiving additional loss data, and
adding the additional loss data to the pivot table in accordance with the spreadsheet application customization.

13. The system of claim 1, wherein the memory further stores program instructions for execution by the computer processor for:
exporting a portion of the pivot table.

14. The system of claim 1, wherein the loss data includes a policy identifier, a claim number, a cost, and at least two of: (i) a line of business code, (ii) a claimant name, (iii) a claimant birth date, (iv) a claimant age, (v) a claimant gender, (vi) a claimant date hired, (vii) a claimant length employed, (viii) an accident date, (ix) an accident time, (x) an accident state, (xi) an accident city, (xii) a location name, (xiii) a location code, (xiv) a claim description, (xv) an accident description, (xvi) a claimant occupation, (xvii) an injured body part and injury type, (xviii) a claim status, (xix) a number of disability days, (xx) a date reported to carrier, (xxi) a date reported by claimant, (xxii) a total paid cost, and (xxiii) a total incurred cost.

15. The system of claim 1, wherein the loss data is summarized in accordance with at least one of: (i) line of business, (ii) loss size, (iii) loss stratification, (iv) claim status, (v) reporting timeliness, (vi) month, (vii) day of week, (viii) state and/or city, (ix) occupation, (x) length employed, (xi) age, (xii) claim type, (xiii) contributing factor descriptions, and (xiv) body part.

16. A computer-implemented method for analyzing loss data, comprising:
receiving, via a communication device from a plurality of sources, loss data associated with insurance claims submitted under an insurance policy;
using, by a computer processor, the received loss data to populate cells in a pivot data worksheet in a spreadsheet application workbook; and
automatically creating, by the computer processor based on the pivot data worksheet, at least one pivot table in at least one pivot table worksheet of the spreadsheet application workbook, the pivot table including cells that summarize the loss data associated with the insurance claims submitted under the insurance policy.

17. The method of claim 16, wherein said using the received loss data includes:
importing, by the computer processor, the data into a download data worksheet; and
mapping, by the computer processor, cells of the download data worksheet to cells of the pivot data worksheet.

18. The method of claim 16, further comprising:
prior to said automatic creation of the at least one pivot table, facilitating, by the computer processor, a manual entry of supplemental loss data by a data analyst.

19. The method of claim 16, further comprising:
prior to said automatic creation of the at least one pivot table, automatically applying by the computer processor at least one algorithm to populated cells in the pivot data worksheet.

20. The method of claim 16, further comprising:
receiving, by the computer processor from a data analyst, at least one filtering criteria; and
filtering, by the computer processor, information in the pivot table based on the received filtering criteria.

21. The method of claim 20, further comprising:
receiving, by the computer processor from the data analyst, at least one sorting criteria; and
sorting, by the computer processor, information in the pivot table based on the received sorting criteria.

22. The method of claim 16, further comprising:
receiving, by the computer processor from a data analyst, at spreadsheet application workbook customization;
storing, by the computer processor, the spreadsheet application workbook customization;
receiving, by the computer processor, additional loss data; and
adding, by the computer processor, the additional loss data to the pivot table in accordance with the spreadsheet application customization.

23. A non-transitory computer-readable medium storing instructions adapted to be executed by a computer processor to perform a method for analyzing loss data, said method comprising:
receiving, via a communication device from a plurality of sources, loss data associated with insurance claims submitted under an insurance policy;
using the received loss data to populate cells in a pivot data worksheet in a spreadsheet application workbook; and
automatically creating, by a computer processor based on the pivot data worksheet, at least one pivot table in at least one pivot table worksheet of the spreadsheet application workbook, the pivot table including cells that summarize the loss data associated with the insurance claims submitted under the insurance policy.

24. The medium of claim 23, wherein said using the received loss data includes:
importing the data into a download data worksheet; and
mapping cells of the download data worksheet to cells of the pivot data worksheet.

25. The medium of claim 23, further comprising:
prior to said automatic creation of the at least one pivot table, facilitating a manual entry of supplemental loss data by a data analyst.

26. The medium of claim 23, further comprising:
prior to said automatic creation of the at least one pivot table, automatically applying by the computer processor at least one algorithm to populated cells in the pivot data worksheet.

27. The medium of claim 23, further comprising:
receiving from a data analyst at least one filtering criteria;
filtering information in the pivot table based on the received filtering criteria;
receiving from the data analyst at least one sorting criteria; and
sorting information in the pivot table based on the received sorting criteria.

28. The medium of claim 23, further comprising:
receiving from a data analyst at spreadsheet application workbook customization;
storing the spreadsheet application workbook customization;
receiving additional loss data; and
adding the additional loss data to the pivot table in accordance with the spreadsheet application customization.
